(19) United States
(12) Patent Application Publication
(10) Pub. No.: US 2026/0335153 A1
(43) Pub. Date: Oct. 29, 2026

(54) INFANT TRANSFER DEVICE

(71) Applicant: Regents of the University of Minnesota, Minneapolios, MN (US)

(72) Inventors: Nathan Alan Johnson, Eagan, MN (US); Joseph Broomhead, Minneapolis, MN (US); Kari Roberts, St. Paul, MN (US)

(21) Appl. No.: 19/661,195

(22) Filed: Apr. 28, 2026

Related U.S. Application Data
(60) Provisional application No. 63/796,678, filed on Apr. 29, 2025.

(51) Int. Cl. A61G 1/04; A61G 1/013

(52) U.S. Cl. CPC A61G 1/04; A61G 1/013; A61G 2200/14

(57) ABSTRACT

A transfer device includes a frame assembly and a hammock suspended by the frame assembly. The frame assembly includes a rail and one or more connectors connected to the rail. The one or more connectors are configured to couple with a medical line to secure the medical line relative to the rail. The hammock forms an area configured to capture the infant within the frame assembly.

### CROSS-REFERENCE TO RELATED MATTERS

This application claims the benefit of the filing date of U.S. Provisional Application Ser. No. 63/796,678, filed Apr. 29, 2025, which application is incorporated herein by reference in its entirety.

### TECHNICAL FIELD

This document pertains generally, but not by way of limitation, to an infant transfer device, and in particular, a neonatal transportation device.

### BACKGROUND

In neonatal intensive care units (NICUs), the care of infants or neonates involves using numerous medical lines and devices attached to the neonate. These medical lines are used for delivering medications, providing respiratory support, and monitoring vital signs, and are typically connected to the neonate during treatment. The complexity and volume of the medical lines can create significant challenges for routine care, particularly during the transfer of infants from a bed to a caregiver or parent's arms.

Often, a team of nurses carefully handles and organizes the medical lines to prevent dislodgment from contact with a neonate during the transfer of the neonate between a bed and a caregiver or parent's arms.

Skin-to-skin contact between a mother and child improves neonatal health outcomes, including reduced mortality and shorter hospital stays. Without an easy method to facilitate skin-to-skin contact, the health and recovery of a neonate are negatively impacted.

Current solutions lack a streamlined approach to safely and efficiently transfer a neonate from a bed to a mother's arms.

### OVERVIEW

A transfer device includes a frame assembly and a hammock suspended by the frame assembly. The frame assembly includes a rail and one or more connectors connected to the rail. The one or more connectors are configured to couple with a medical line to secure the medical line relative to the rail. The hammock forms an area configured to capture the infant within the frame assembly.

The present inventors have recognized, among other things, that a problem to be solved can include the transfer of neonates from a bed to a caregiver or parent's arms to assist with and facilitate skin-to-skin contact. The present subject matter can help provide a solution to this problem, such as by providing a transfer device having a frame that secures a medical line during the transfer and while a caregiver or parent holds the neonate.

Each of these non-limiting examples can stand on its own or can be combined in various permutations or combinations with one or more of the other examples.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a perspective view of a transfer device according to one example.

FIG. 2 illustrates a top-down view of a hammock according to one example.

FIG. 3 illustrates a perspective view of a frame assembly according to one example.

FIG. 4 illustrates an isometric view of a frame assembly according to one example.

FIG. 5 illustrates an isometric view of a portion of a frame assembly according to one example.

FIG. 6A illustrates an isometric view of a portion of a frame assembly in a first configuration according to one example.

FIG. 6B illustrates an isometric view of a portion of a frame assembly in a second configuration according to one example.

FIG. 7A illustrates an isometric view of a first fixture connector according to one example.

FIG. 7B illustrates a top-down view of a first fixture connector according to one example.

FIG. 7C illustrates a side view of a first fixture connector according to one example.

FIG. 8 illustrates an isometric view of a third fixture connector according to one example.

FIG. 9A illustrates a perspective view of a portion of a transfer device in a first configuration according to one example.

FIG. 9B illustrates a perspective view of a portion of a transfer device in a second configuration according to one example.

FIG. 10 illustrates a perspective view of a portion of a transfer device according to one example.

FIG. 11 illustrates a perspective view of an adjustable harness according to one example.

FIG. 12 illustrates a perspective view of a portion of an adjustable harness according to one example.

FIG. 13 illustrates a perspective view of a harness connection system according to one example.

FIG. 14 illustrates a perspective view of a portion of an adjustable harness according to one example.

FIG. 15 illustrates a perspective view of a portion of an adjustable harness according to one example.

FIG. 16A illustrates a front view of an adjustable harness, a transfer device, and an adjustable strap system in a first configuration according to one example.

FIG. 16B illustrates a side view of an adjustable harness, a transfer device, and an adjustable strap system in the first configuration according to one example.

FIG. 17A illustrates a front view of an adjustable harness, a transfer device, and an adjustable strap system in a second configuration according to one example.

FIG. 17B illustrates a side view of an adjustable harness, a transfer device, and an adjustable strap system in the second configuration according to one example.

FIG. 18 illustrates a perspective view of a transfer device according to an example.

FIG. 19 illustrates a perspective view of a transfer device according to an example.

FIG. 20 illustrates a method for transporting an infant in accordance with one embodiment according to one example.

### DETAILED DESCRIPTION

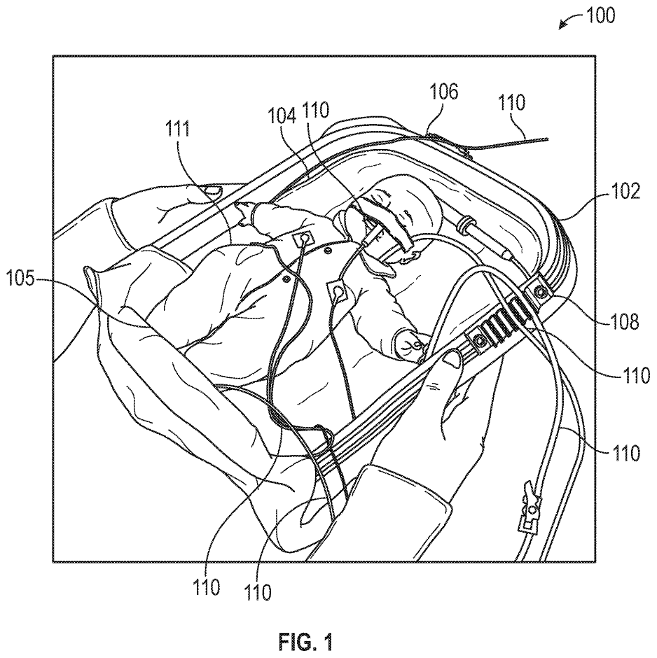

FIG. 1 illustrates a perspective view of a transfer device 100 according to one example. The transfer device 100 can include a frame assembly 102, a hammock 104, a hammock pouch 105, a first fixture connector 106, a second fixture connector 108, a medical line 110, and an infant 111.

The frame assembly 102 can form the foundation of the transfer device 100. The hammock 104 can be suspended by the frame assembly 102. A portion (e.g., an end or the like) of the hammock 104 can form the hammock pouch 105, such as when the hammock 104 is suspended by the frame assembly 102. The first fixture connector 106 can be attached to the frame assembly 102. The medical line 110 can be coupled to the first fixture connector 106.

The frame assembly 102 can include a support structure for the transfer device 100. The hammock 104 can provide an area to capture and to support the infant 111. The hammock pouch 105 can provide a pouch to capture and support the infant 111 while the transfer device 100 is in use. For example, a portion of the infant 111 can rest inside the hammock pouch 105 if the transfer device 100 is rotated while in use. In some examples, the hammock 104 can be folded on one end to create or form the hammock pouch 105. In some examples, the rail 103 can include a U-shape with a first end and a second end defining a gap therebetween. A hammock end of the hammock 104 can be folded over both the first end and the second end of the rail 103 to form the hammock pouch 105 at the gap, such that the hammock pouch 105 can be configured to receive one or more feet of the infant 111. In other examples, the hammock 104 can include an additional pocket that is sewn or otherwise attached to the hammock 104 to create the hammock pouch 105. The first fixture connector 106 and the second fixture connector 108 can secure (e.g., limit or inhibit movement) one or more medical lines of various diameters and sizes. The medical line 110 can include a medical line attached to the infant 111 to provide medical support for neonatal care, such as support for intravenous fluids, medication, or monitoring support.

During operation, the infant 111 can be placed on the hammock 104, which can be supported by the frame assembly 102. The medical line 110 can be connected to the infant 111 or can already be connected. The medical line 110 can be routed through a fixture connector, such as the first fixture connector 106 or the second fixture connector 108. At least one person can move the transfer device 100 and can lift the infant 111 off a NICU bed to capture the infant 111 within the transfer device 100. In some examples, the transfer device 100 can lay on top of a NICU bed even when not actively transporting the infant 111.

The transfer device 100 can enable transportation of a neonate while also maintaining one or more medical lines connected to the neonate. The design of the transfer device 100 can provide for efficient movement between a NICU bed and a caregiver's arms, such as by reducing the amount of medical personnel used during a transfer to prevent dislodgement of the medical line 110 from the infant 111. The transfer device 100 can be easily operated by an end-user without complex mechanical devices or previous experience.

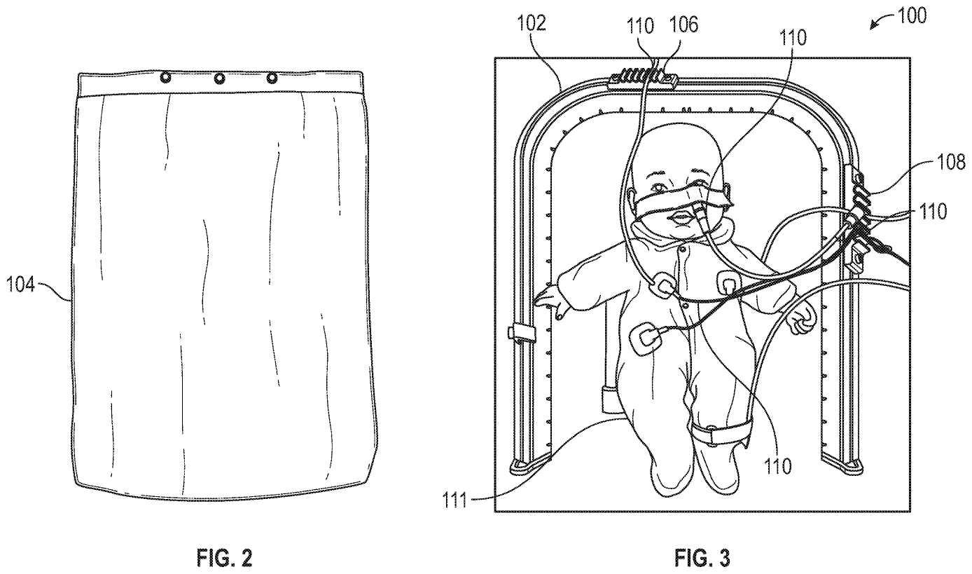

FIG. 2 illustrates a top-down view of a hammock 104 according to one example. The hammock can include a textile or other material that forms a hammock-like structure when suspended by the frame assembly 102.

The hammock 104 can support the infant 111 during transport when the hammock 104 is attached to the frame assembly 102. The hammock 104 can include a natural material (e.g., linen, cotton, wool, silk, hemp, or the like) or a synthetic material (e.g., polyester, nylon, acrylic, microfiber, or the like) that can provide comfort for the baby while allowing cleaning and sterilization. The hammock 104 can include a reusable material or can include a single-use material. The hammock 104 can distribute a weight of the infant 111 evenly across the hammock 104 while the hammock is suspended by the frame assembly 102. In some examples, the hammock 104 can be made from the same material as a sheet or a fabric on the surface of a NICU bed. In other examples, the hammock 104 can be made from a separate material from those used on the surface of a NICU bed.

The hammock 104 can provide a comfortable and secure area for the neonate. Because the hammock 104 uses a material that can be cleaned or replaced, the hammock 104 can provide a low-cost mechanism to support the infant 111.

FIG. 3 illustrates a perspective view of a frame assembly 102 according to one example. The transfer device 100 can include the frame assembly 102, a first fixture connector 106, a second fixture connector 108, a medical line 110, and an infant 111.

The frame assembly 102 can be manufactured from 3D-printed resins or polymers, aluminum, or other materials that can be sterilized, are lightweight, are sturdy, or the like. The frame assembly 102 can be sized such that the frame assembly 102 fits within a typical NICU bed. A typical NICU bed can have a length of 48 inches, 36 inches, 28 inches, or 24 inches. A typical NICU bed can have a width of 30 inches, 24 inches, 20 inches, 18 inches, 14 inches, or 12 inches. In some examples, the frame assembly 102 can define a U-shape with a gap between a first end of the U-shape and a second end of the U-shape. In other examples, the frame assembly 102 can define another shape with or without a gap or an opening, such as an O-shape, a square shape, a triangular shape, or the like.

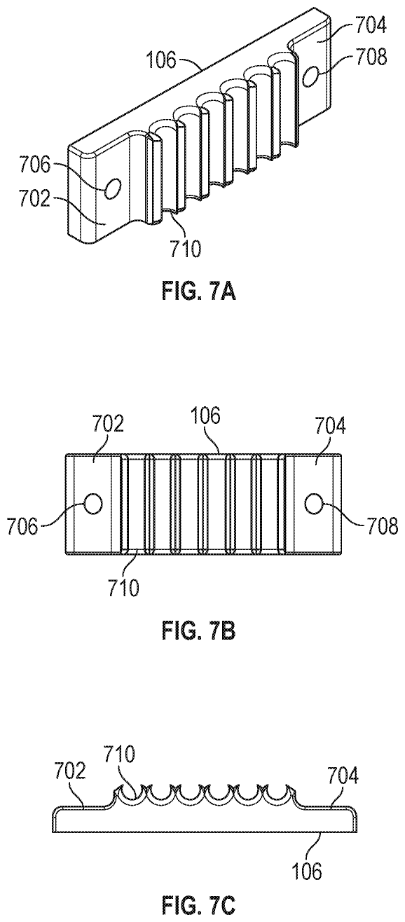

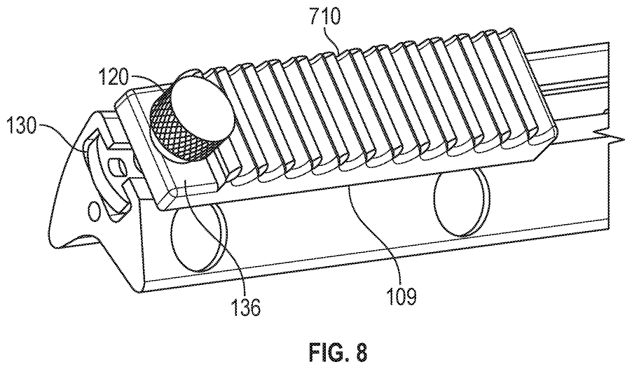

The first fixture connector 106 can provide a surface to attach the medical line 110. Attaching the medical line 110 to the first fixture connector 106 can transfer any mechanical pull on the medical line 110 from the infant 111 to the frame assembly 102. The first fixture connector 106 can include different securing mechanisms for medical lines, as discussed in depth regarding FIGS. 7A-C. The first fixture connector 106 can be positioned at various locations along the frame assembly 102. The first fixture connector 106 can be movably coupled to the frame assembly 102. In examples, the transfer device 100 can include any number of fixture connectors (e.g., the first fixture connector 106, the second fixture connector 108, or the like), such as one, two, three, four, or more fixture connectors.

The second fixture connector 108 can provide a surface to attach the medical line 110. The second fixture connector 108 can be movably coupled to the frame assembly 102. The second fixture connector 108 can be similar to, interchangeable with, or substituted for the first fixture connector 106. The second fixture connector 108 can have a different length than the first fixture connector 106, as seen in FIG. 1, and can accommodate a different quantity of medical line 110 than the first fixture connector 106.

The medical line 110 can include a medical line attached to the infant 111 to provide medical support for neonatal care, such as support for intravenous fluids, medication, or monitoring support. The medical line 110 can include any combination of an intravenous line, a monitoring cable, a ventilator tube, an endotracheal tube, respiratory support tubing, or the like. The medical line 110 can include a first end and a second end. The first end of the medical line 110 can be attached to a medical instrument. The second end of the medical line 110 can be attached to the infant 111.

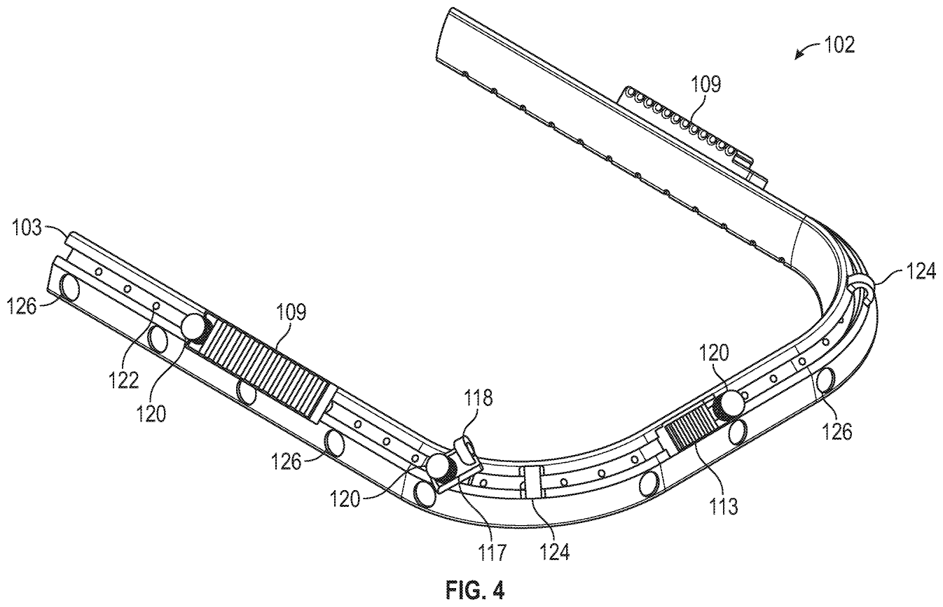

FIG. 4 illustrates an isometric view of a frame assembly 102 according to one example. The frame assembly 102 can include a rail 103, a third fixture connector 109, a fourth fixture connector 113, a hook plate 117, a middle hook 118, one or more fasteners 120, a fastener receiver 122, a stopper 124, and a hammock fastener aperture 126.

The rail 103 can include a part of the frame assembly 102 and can provide a surface for the frame assembly 102 to interact with the third fixture connector 109, the fourth fixture connector 113, the hook plate 117, and the stopper 124. The third fixture connector 109 and the fourth fixture connector 113 can each be attached to the frame assembly 102. In some examples, the third fixture connector 109, the fourth fixture connector 113, or any combination thereof can be movably coupled with the rail 103.

The hook plate 117 can be attached to the frame assembly 102 and can interface with the frame assembly 102 to provide a frame connection interface, such as via the middle hook 118. In some examples, the hook plate 117 can be movably coupled with the rail 103. For example, the hook plate 117, the middle hook 118, or a combination thereof can be slidably engaged with the rail 103, such that the hook plate 117 can move along the rail (e.g., between a first rail end and a second rail end). The hook plate 117 can be rotatably coupled to the frame assembly 102, such that the transfer device 100 can be rotatable relative to a harness or other transfer device carrying system (e.g., the adjustable harness 1100 of FIG. 11).

The one or more fasteners 120 can include a securing mechanism that can interface with the frame assembly 102 at a fastener receiver 122, such as to secure each of the hook plate 117 or any of the fixture connectors. The one or more fasteners 120 can prevent, inhibit, or limit the hook plate 117 or any of the fixture connectors from moving on the rail when in use. The fastener receiver 122 can include a recess in the frame assembly 102 configured to receive the one or more fasteners 120. In some examples, the one or more fasteners 120 can interact with the frame assembly 102 through a pressure fit outside of the fastener receiver 122. The one or more fasteners 120 can be selectively removable from the hook plate 117, the frame assembly 102, the fastener receiver 122, or the like.

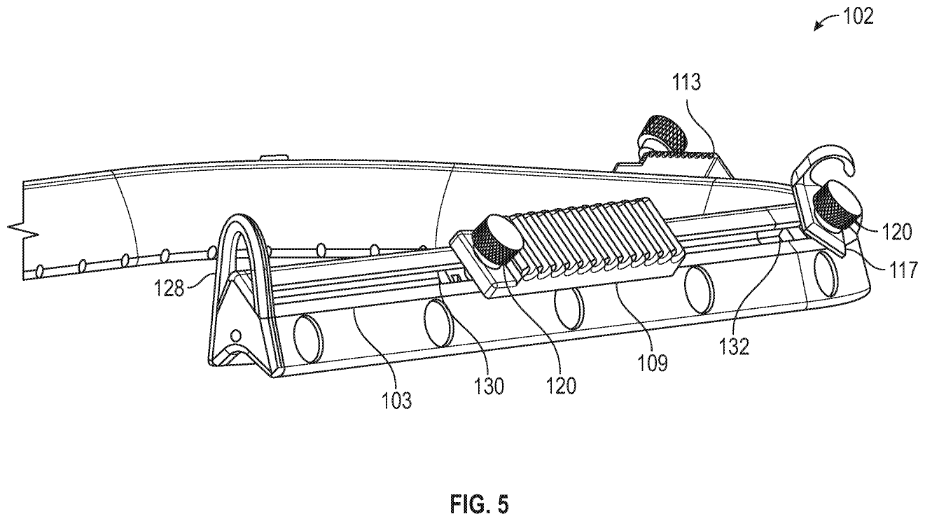

The stopper 124 can be coupled to the rail 103. The stopper 124 can be configured to limit or inhibit travel of one or more movable components along the rail 103, such as the third fixture connector 109, the one or more fasteners 120, the hook plate 117, the fixture slider 130 of FIG. 5, the hook slider 132 of FIG. 5, or the like. For example, the stopper 124 can engage at least a portion of one or more fixture connectors or the hook plate 117, such as to prevent the slidable components from moving past a defined location on the rail 103. The stopper 124 can be positioned at an end of the rail 103, at an intermediate location along the rail 103, or a combination thereof, such as to define one or more boundaries for travel of the slidable components. In some examples, the stopper 124 can be fixedly coupled to the rail 103, such as via a fastener, an adhesive, a press fit, or an integrally formed feature of the rail 103. In other examples, the stopper 124 can be removably or repositionably coupled to the rail 103, such as to allow adjustment of the travel boundary. The stopper 124 can help retain the fixture slider 130, the hook slider 132, the third fixture connector 109, the fourth fixture connector 113, the hook plate 117, or any combination thereof on the rail 103 during use of the transfer device 100.

The third fixture connector 109 can provide a surface to attach the medical line 110 to. The third fixture connector 109 can be similar to, interchangeable with, or substituted for each of the first fixture connector 106 or the second fixture connector 108. The third fixture connector 109 can have a different length than the first fixture connector 106, as seen in FIG. 1, and can accommodate a different quantity of medical line 110 than the first fixture connector 106. The third fixture connector 109 can be coupled to a fastener of the one or more fasteners 120.

The fourth fixture connector 113 can provide a surface to attach the medical line 110. The fourth fixture connector 113 can be similar to, interchangeable with, or substituted for each of the first fixture connector 106, the second fixture connector 108, or the third fixture connector 109. The fourth fixture connector 113 can have a different length than the first fixture connector 106, as seen in FIG. 1, and can accommodate a different quantity of medical line 110 than the first fixture connector 106. The fourth fixture connector 113 can be coupled to a fastener of the one or more fasteners 120.

The frame assembly 102 can include the first fixture connector 106 as seen in FIG. 1, the second fixture connector 108 as seen in FIG. 1, the third fixture connector 109 as seen in FIG. 4, the fourth fixture connector 113 as seen in FIG. 4, or any combination thereof. The first fixture connector 106 can be similar to, interchangeable with, or substituted for the second fixture connector 108, the third fixture connector 109, and the fourth fixture connector 113. The second fixture connector 108 can be similar to, interchangeable with, or substituted for the first fixture connector 106, the third fixture connector 109, and the fourth fixture connector 113. The third fixture connector 109 can be similar to, interchangeable with, or substituted for the first fixture connector 106, the second fixture connector 108, or the fourth fixture connector 113. The fourth fixture connector 113 can be similar to, interchangeable with, or substituted for the first fixture connector 106, the second fixture connector 108, or the third fixture connector 109. Alternatively, it is contemplated in some examples that the first fixture connector 106, the second fixture connector 108, the third fixture connector 109, and the fourth fixture connector 113 can have a unique design so as not to be interchangeable but so as to couple with the rail 103 in one or more positions, such as the positions shown in FIG. 4. Although four fixture connectors are illustrated, other examples contemplate the use of fewer fixture connectors (e.g., one, two, three, or the like) or more fixture connectors (e.g., five, six, seven, or the like).

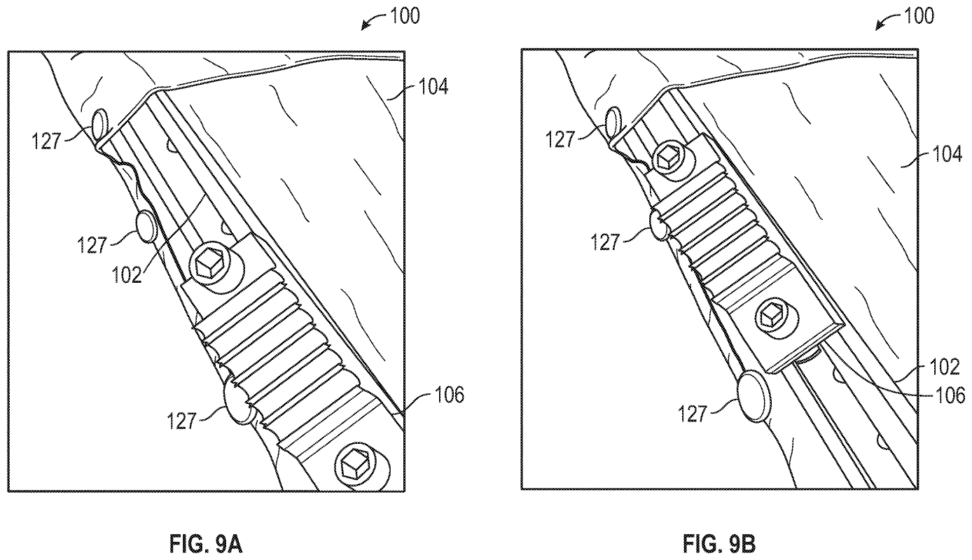

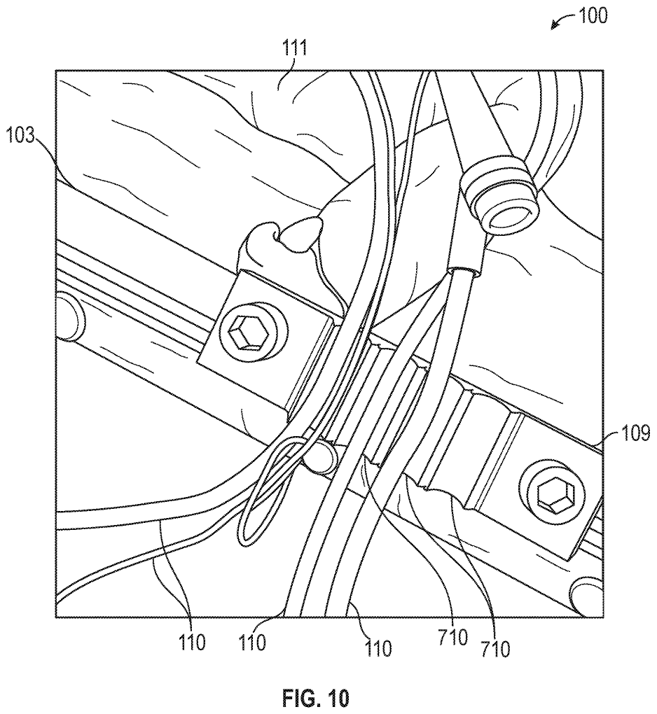

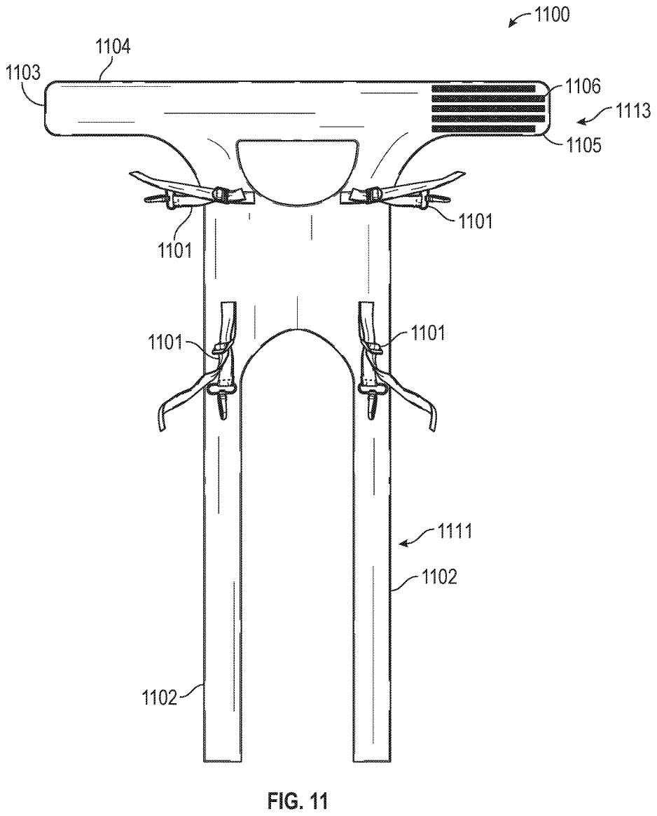

The hammock fastener aperture 126 can include a hole, aperture, or other recess in the frame assembly 102 configured to receive a hammock fastener 127 (e.g., as shown in FIG. 9A). The hammock fastener aperture 126 can receive the hammock fastener 127 to secure a hammock 104 to the frame assembly 102 for the hammock 104 to suspend from the frame assembly 102. The hammock fastener aperture 126 can be sized and shaped to accommodate various sizes and types of fasteners. In some examples, one or more of the hammock fastener aperture 126 can be positioned along the frame assembly 102 to provide a plurality of attachment interfaces for the hammock 104.

FIG. 5 illustrates an isometric view of a portion of a frame assembly 102 according to one example. The frame assembly 102 can include a rail 103, a third fixture connector 109, a fourth fixture connector 113, one or more fasteners 120, an end hook 128, a fixture slider 130, and a hook slider 132.

The rail 103 can form a track for a component, such as the fixture slider 130 or the hook slider 132, to move along the frame assembly 102. The fixture slider 130 can be coupled to the third fixture connector 109 by the one or more fasteners 120. The hook slider 132 can be coupled to the hook plate 117 by the one or more fasteners 120. The fixture slider 130 and the hook slider 132 can be sized and shaped to interface with the rail 103 to move along the track formed by the rail 103. As discussed below in FIG. 11, the end hook 128 can include a frame connection interface for coupling with an attachment mechanism, such as the adjustable strap system 1101.

The rail 103 can include a T-shaped profile to create or form a track system along the frame assembly 102 that enables moving functionality of the third fixture connector 109 or the hook plate 117. The T-shaped profile can include a stem (e.g., a vertical stem) with a crossbar (e.g., a horizontal crossbar or the like), such as to form a T-shape when viewed in cross-section. The crossbar can provide a channel for the fixture slider 130 and the hook slider 132, and the stem can provide a channel for the one or more fasteners 120 to reach the fixture slider 130 and the hook slider 132, while providing a ceiling for the fixture slider 130 and the hook slider 132. In some examples, the T-shaped rail profile can fully extend around the frame assembly 102, including a corner or any curved portion. In some examples, the rail 103 can include an alternative profile with similar properties, such as an I-beam profile, a dovetail profile, a C-channel profile, or an L-shaped profile.

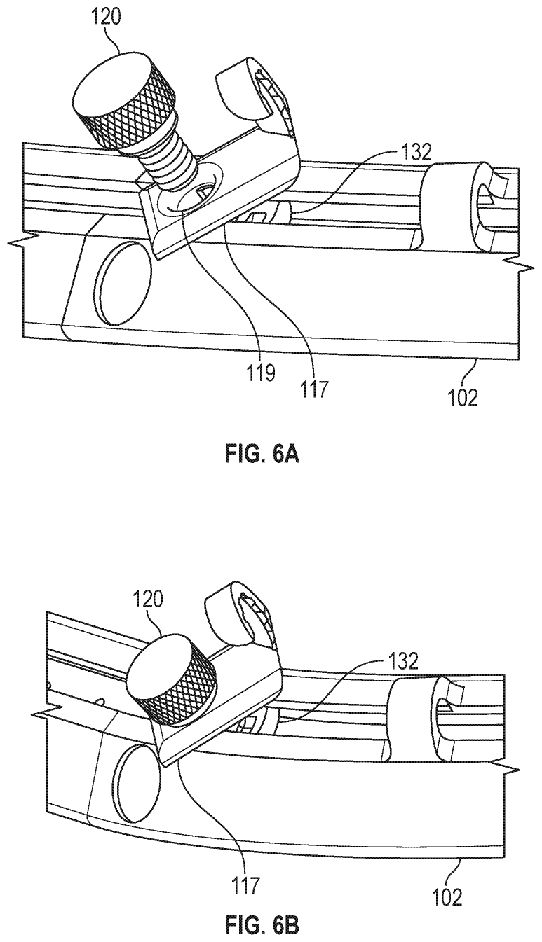

The fixture slider 130 can interface with the rail 103 such that the fixture slider 130 can move along the rail 103 relative to the frame assembly 102 without becoming dislodged from the rail 103. The fixture slider 130 can be coupled to the third fixture connector 109 by the one or more fasteners 120. The third fixture connector 109 can include a fixture connector aperture to provide an aperture sized for the one or more fasteners 120, similar to the hook plate aperture 119 discussed in FIGS. 6A and 6B. Because the one or more fasteners 120 couple the fixture slider 130 to the third fixture connector 109, the movement of the third fixture connector 109 is restricted by the movement of the fixture slider 130. In some examples, a corresponding pair of the third fixture connector 109 and the fixture slider 130 can be manufactured as a single component. In those examples, the single component can include a complementary T-shaped profile that can correspond to the T-shaped profile of the rail 103, allowing the single component to move along the rail while maintaining a secure connection.

The hook slider 132 can be similar to the fixture slider 130. The hook slider 132 can be coupled to the hook plate 117 by the one or more fasteners 120. Because the one or more fasteners 120 couple the hook slider 132 to the hook plate 117, the movement of the hook plate 117 is restricted by the movement of the hook slider 132. In some examples, the hook slider 132 can have the same size and shape as the fixture slider 130. In some examples, the hook plate 117 and the hook slider 132 can be manufactured as a single component. In those examples, the single component can include a complementary T-shaped profile corresponding to the T-shaped profile of the rail 103, allowing the single component to move along the rail while maintaining a secure connection.

The end hook 128 (e.g., a frame connection interface) can provide a coupling interface on the frame assembly 102. The end hook 128 can be located at an end of the frame assembly 102, as seen in FIG. 5, or can be located elsewhere along the frame. In some examples, a connection interface can be coupled to one or more of the fixture connectors (e.g., the first fixture connector 106, the second fixture connector 108, the third fixture connector 109, the fourth fixture connector 113, or a combination thereof), such that the transfer device 100 can be coupled to a harness (e.g., the adjustable harness 1100 of FIG. 11) or other carrying system, such as via a connection interface disposed on a fixture connector.

Because the frame assembly 102 uses a relatively simple design for the rail 103 design that can both secure and move the third fixture connector 109 and the hook plate 117, the frame assembly 102 can provide an easy-to-manufacture and easy-to-use device for transferring neonates. The adjustability of the frame assembly 102 enables adaptation to different patient uses.

FIG. 6A illustrates an isometric view of a portion of a frame assembly 102 in a first configuration according to one example. FIG. 6B illustrates an isometric view of a portion of a frame assembly 102 in a second configuration according to one example. FIGS. 6A-B are discussed below and show additional details of the frame assembly 102. The frame assembly 102 can include a hook plate 117, a hook plate aperture 119, one or more fasteners 120, and a hook slider 132.

The hook plate 117 can include the hook plate aperture 119 to provide an aperture sized for the one or more fasteners 120. The one or more fasteners 120 can couple the hook plate 117 to the hook slider 132 through the hook plate aperture 119.

During operation, the hook plate 117 can be aligned with the hook slider 132 such that the hook plate aperture 119 aligns with a corresponding aperture in the hook slider 132. The one or more fasteners 120 can be inserted through both the hook plate aperture 119 and the aperture in the hook slider 132 to secure the hook plate 117 to the hook slider 132. The one or more fasteners 120 can be tightened or inserted further to secure both the hook plate 117 and the hook slider 132 to the rail 103 at a desired location on the rail 103. In the first configuration, shown in FIG. 6A, the one or more fasteners 120 can be loosened, allowing the hook slider 132 to move freely along the rail. The one or more fasteners 120 can be loosened to remove the one or more fasteners 120 from the hook plate 117 or the hook slider 132, or the one or more fasteners 120 can be loosened partially. By loosening the one or more fasteners 120 partially, the hook plate 117 can be movable along the rail 103 without aligning the hook plate aperture 119 and the hook slider 132 when securing the position of the hook plate 117. In the second configuration, shown in FIG. 6B, the one or more fasteners 120 can be tightened, securing the hook slider 132 at a location along the rail 103.

Coupling the hook plate 117 with the one or more fasteners 120 to the hook slider 132 provides a simple yet effective method for adjusting and securing the hook plate 117 to the rail 103 of the frame assembly 102. The design allows for customization of the transfer device 100 to accommodate different sizes of a baby and different configurations of a medical line, depending on use.

FIG. 7A illustrates an isometric view of the first fixture connector 106 according to one example. FIG. 7B illustrates a top-down view of the first fixture connector 106 according to one example. FIG. 7C illustrates a side view of the first fixture connector 106 according to one example. FIGS. 7A-C are discussed together below and show additional details of the first fixture connector 106. The first fixture connector 106 can include a first fixture connector plate 702, a second fixture connector plate 704, a first fixture connector plate aperture 706, a second fixture connector plate aperture 708, and a fixture channel 710.

The first fixture connector plate 702 can provide a surface on the first fixture connector 106 for the first fixture connector plate aperture 706. The second fixture connector plate 704 can provide a surface on the first fixture connector 106 for the second fixture connector plate aperture 708. The first fixture connector plate aperture 706 and the second fixture connector plate aperture 708 can each be apertures in the first fixture connector 106 to interface with a fastener, such as the one or more fasteners 120, as seen in FIG. 9A and FIG. 9B. The first fixture connector plate 702 and the first fixture connector plate aperture 706 can facilitate coupling the fixture connector to a fixture slider, such as the fixture slider 130, as shown in FIG. 5 with the third fixture connector 109 and the fixture slider 130. The second fixture connector plate 704 and the second fixture connector plate aperture 708 can couple the first fixture connector 106 to a second fixture slider as a backup or failsafe, or for additional security. In some examples, the first fixture connector 106 can have a single fixture connector plate. In those examples, the first fixture connector 106 can have a single fixture connector plate aperture disposed on the fixture connector plate.

As seen in FIGS. 9A-B, the fixture channel 710 can include a surface on the first fixture connector 106 configured to receive a medical line, such as the medical line 110. The fixture channel 710 can secure a medical line such that the medical line redirects a mechanical force to the fixture channel 710 rather than onto a baby. The first fixture connector 106 can include any number of the fixture channel 710. In some examples, the fixture channel 710 can include a channel sized to form a snap-fit or similar frictional fit with the medical line. In these examples, the channel can prevent a movement of the medical line by the frictional counterforce. In other examples, the fixture channel 710 can include or can be modified to utilize another fixture or capture device, such as but not limited to a clasp, buckle, pin, or other mechanical feature or fastener, to secure the medical line.

Because the first fixture connector 106 has a simple design, a user can quickly insert or remove medical lines as desired. The design of the first fixture connector 106 provides an intuitive use for a user and does not rely on complex mechanical processes to either secure a medical line or move the first fixture connector 106 relative to a frame.

FIG. 8 illustrates an isometric view of a third fixture connector 109 according to one example. The third fixture connector 109 can include one or more fasteners 120, a fixture slider 130, a fixture channel 710, and a fixture connector plate 136.

The fixture connector plate 136 can provide an aperture, such as a first fixture connector plate aperture 706 in FIGS. 7A-B, sized for the one or more fasteners 120. The one or more fasteners 120 can couple the third fixture connector 109 to the fixture slider 130 through the aperture in the fixture connector plate 136.

During operation, the fixture connector plate 136 can be aligned with the fixture slider 130 such that an aperture in the fixture connector plate 136 aligns with a corresponding aperture in the fixture slider 130. The one or more fasteners 120 can be inserted through the aperture in the fixture connector plate 136 and the fixture slider 130 to secure the third fixture connector 109 to the fixture slider 130. The one or more fasteners 120 can be tightened or inserted further to prevent the third fixture connector 109 from moving relative to a frame. The one or more fasteners 120 can be loosened partially to move the third fixture connector 109 and the fixture slider 130 relative to the frame. The one or more fasteners 120 can then be tightened when the third fixture connector 109 is at a desired location along the frame to secure a corresponding pair of the third fixture connector 109 and the fixture slider 130 at the desired location. By moving the third fixture connector 109, a user can adjust the location of the fixture channel 710 based on an orientation of a baby or a placement of the medical devices that a medical line may originate from.

Coupling the third fixture connector 109 with the one or more fasteners 120 to the fixture slider 130 provides a simple yet effective method for adjusting and securing the third fixture connector 109 to the frame. The design allows for customization of the transfer device 100 to accommodate different sizes of a baby or different orientations of the baby and different configurations of a medical line, depending on use. The ability to quickly loosen the one or more fasteners 120 for adjustment and then tighten the one or more fasteners 120 to secure a position of the third fixture connector 109, and thereby the fixture channel 710, can improve versatility and utility of the transfer device 100.

FIG. 9A illustrates a perspective view of a portion of a transfer device 100 in a first configuration according to one example. FIG. 9B illustrates a perspective view of a portion of a transfer device 100 in a second configuration according to one example. FIGS. 9A-B are discussed below and show additional details of the transfer device 100. The transfer device 100 can include a frame assembly 102, a hammock 104, a first fixture connector 106, and a hammock fastener 127.

As discussed in FIG. 8, the first fixture connector 106 can be moved relative to the frame assembly 102. As shown in FIGS. 9A and 9B, the first fixture connector 106 can be positioned along the frame assembly 102 to accommodate various configurations of medical lines, baby orientations, or baby sizes.

As discussed in FIG. 4, the frame assembly 102 can include a hammock fastener aperture 126. The hammock fastener 127 can interact with the hammock fastener aperture 126 to secure the hammock 104 to the frame assembly 102. The hammock fastener 127 can be removable or secured in place. In some examples, the hammock fastener 127 can include a frictional fastener, such as a snap fastener, a button, a threaded fastener, or a pin. In other examples, the hammock fastener 127 can include a mechanical fastener, such as a clasp or a hook-and-loop fastener.

The design of a corresponding pair of the hammock fastener 127 and the hammock fastener aperture 126 within the frame assembly 102 can provide simple assembly and disassembly. Further, the design of the hammock fastener 127 can accommodate hammocks made from different materials, as the hammock fastener 127 can pierce the hammock 104 or can clasp the hammock 104.

FIG. 10 illustrates a perspective view of a portion of a transfer device 100 according to one example. The transfer device 100 can include a rail 103, a third fixture connector 109, a medical line 110, an infant 111, and a fixture channel 710.

The third fixture connector 109 can include more than one of the fixture channel 710 to support more than one of the medical line 110, as seen in FIG. 10. In some examples, the third fixture connector 109 can include a plurality of the fixture channel 710, where the plurality of fixture channels can include fixture channels of different shapes, sizes, lengths, or the like. For example, a first fixture channel on a fixture connector can have a first radius, while a second fixture channel on the fixture connector can have a second radius, where the second radius can be a different or similar size relative to the first radius. In some examples, when the medical line 110 is secured to the third fixture connector 109, the third fixture connector 109 can be moved relative to the rail 103 to redirect the location of the medical line 110 compared to the rail 103. In other examples, the third fixture connector 109 can be moved relative to the rail 103 first before securing the medical line 110 to the third fixture connector 109.

By securing a medical line to the third fixture connector 109, the design redirects a force on the medical line from the baby to the third fixture connector 109, thereby reducing the risk of accidental disconnection. The design thus simplifies what would otherwise be a complex transfer and can enable a single person to safely transport the baby while maintaining the medical connections to the baby.

FIG. 11 illustrates a perspective view of an adjustable harness 1100 according to one example. The adjustable harness 1100 can include an adjustable strap system 1101, a shoulder strap 1102, a waist strap 1104, a first waist coupler 1106, a superior portion 1111, and an inferior portion 1113. The waist strap 1104 can include a first end 1103 and a second end 1105.

The adjustable harness 1100 can include a harness worn by a caregiver (e.g., a caretaker, a parent, a nurse, or the like) to interface with a transfer device 100. The adjustable strap system 1101 can be an attachment mechanism disposed on the adjustable harness 1100 to interface with the transfer device 100. The superior portion 1111 can include one or more of the shoulder strap 1102. The superior portion 1111 or the shoulder strap 1102 can at least partially wrap around a shoulder or other body portion (e.g., a neck, a torso, an arm, a stomach, or the like) of the caregiver. The inferior portion 1113 can include the waist strap 1104. The inferior portion 1113 or the waist strap 1104 can be configured to wrap around a waist, or other body portion (e.g., a hip, a stomach, a torso, a thigh, or the like) of the caregiver. The first waist coupler 1106 can include a fastening mechanism coupled to or otherwise disposed on the waist strap 1104 to connect the first end 1103 of the waist strap 1104 to the second end 1105 of the waist strap 1104.

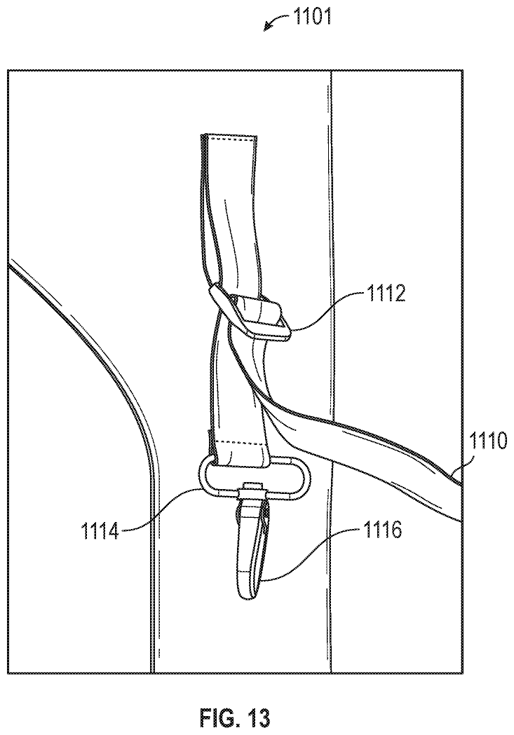

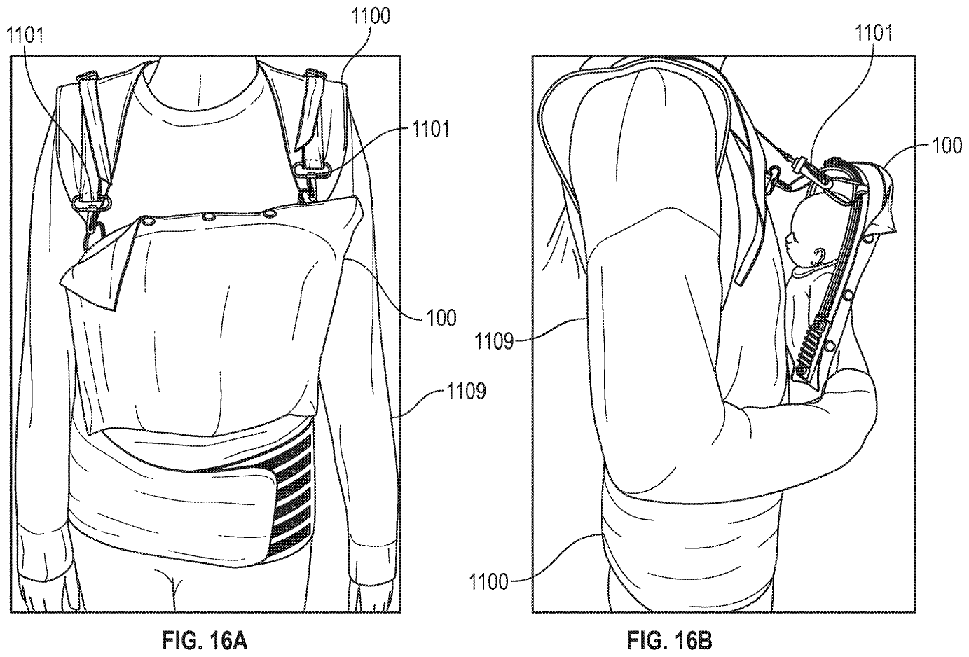

The adjustable strap system 1101 can include a harness attachment interface (e.g., a harness hook 1116, as described with reference to FIG. 13) that can be couplable or connectable to a frame connection interface on a frame assembly 102, such as a middle hook 118 as seen in FIG. 16B, to couple or otherwise secure a transfer device 100 to the adjustable harness 1100. The adjustable strap system 1101 can be adjusted to vary a distance between the frame assembly 102 and the adjustable harness 1100, as discussed in reference to FIG. 13.

The adjustable strap system 1101 can be disposed towards the superior portion of the harness, the inferior portion of the harness, or any combination thereof. For example, the adjustable harness 1100 can include a first adjustable strap system disposed at the superior portion 1111 and a second adjustable strap system disposed at the inferior portion 1113. The first adjustable strap system can include a first harness attachment interface (e.g., the harness hook 1116 or the like) configured to releasably engage with a first frame connection interface on the frame assembly 102. The second adjustable strap system can include a second harness attachment interface (e.g., the harness hook 1116 or the like) configured to releasably engage with a second frame connection interface on the frame assembly 102.

The adjustable harness 1100 can include a substantially symmetrical design about a center axis extending from the superior portion to the inferior portion. The substantially symmetrical design can accommodate different body types depending on the caregiver. The substantially symmetrical design can accommodate breastfeeding from a left breast or a right breast instead of a non-symmetrical design, which can favor a first side when breastfeeding over a second side.

The shoulder strap 1102 can be worn around or over the shoulder of the caregiver. The shoulder strap 1102 can include a load-bearing portion of the adjustable harness 1100 to support a load, such as a weight of the transfer device 100 and a baby. In some examples, the shoulder strap 1102 can include an extension device (e.g., a buckle extender, a slider, a glider, or the like).

The waist strap 1104 can be worn around the waist of the caregiver. The waist strap 1104 can include a load-bearing portion of the adjustable harness 1100 to support a load, such as the weight of the transfer device 100 and the baby. The waist strap 1104 can couple an end of the adjustable harness 1100 to the caregiver to create a secure connection between the caregiver and the adjustable harness 1100. The waist strap 1104 can be worn around other body parts of the caregiver, such as a torso, a hip, a chest, or the like.

The first waist coupler 1106 can include a coupler to connect the first end 1103 of the waist strap 1104 to the second end 1105 of the waist strap 1104. The first waist coupler 1106 can fasten the waist strap 1104 around the caregiver 1109. The first waist coupler 1106 can include an adhesive bond or a mechanical fastener, such as a hook-and-loop fastener, a buckle, a clasp, or a snap connector. In some examples, the waist strap 1104 can include a second waist coupler to interface with the first waist coupler 1106, such as in a hook-and-loop fastening system as seen and discussed with relation to FIG. 15. In those examples, the first waist coupler 1106 can include a hook, while the second waist coupler can include a complementary loop, or vice versa.

In some examples, the caregiver can wear the adjustable harness 1100 with the shoulder strap 1102 over the shoulder of the caregiver and the waist strap 1104 around the waist of the caregiver. The waist strap 1104 can be secured by the first waist coupler 1106. The transfer device 100 containing the baby can then be attached to the adjustable harness 1100 using the adjustable strap system 1101. In other examples, the caregiver can wear either the shoulder strap 1102 or the waist strap 1104 to support the transfer device 100.

The adjustable harness 1100 can provide a secure and comfortable system for the caregiver to hold the transfer device 100 and the infant 111 during transportation and when facilitating skin-to-skin contact. The design of the adjustable harness 1100 can make adjusting the harness easy for the end-user, such as by accommodating different body types of the end-user.

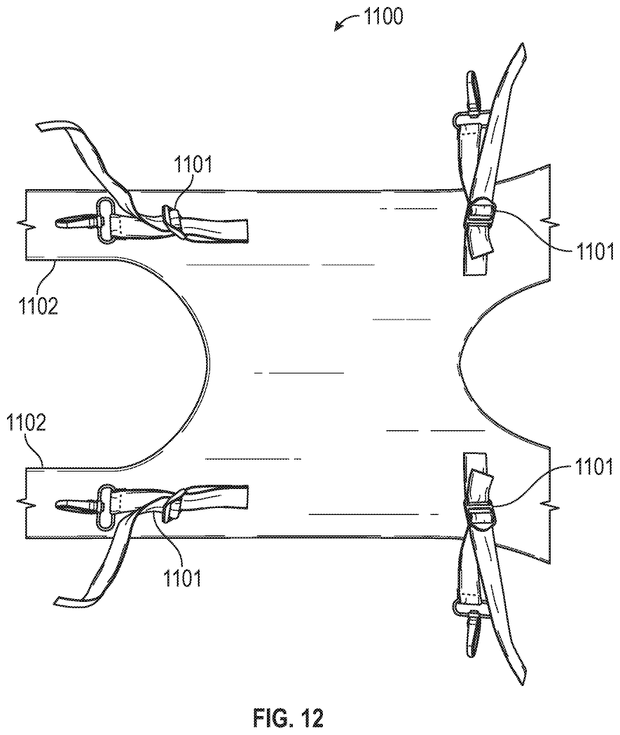

FIG. 12 illustrates a perspective view of a portion of an adjustable harness 1100 according to one example. FIG. 13 illustrates a perspective view of a portion of the adjustable harness 1100 according to one example. FIG. 12 and FIG. 13 are discussed together below and show additional details of the adjustable harness 1100 and the adjustable strap system 1101. The adjustable harness 1100 can include an adjustable strap system 1101 and a shoulder strap 1102. The adjustable strap system 1101 can include a strap 1110, a glider 1112, a harness hook 1116, and a harness hook receiver 1114.

The strap 1110 can be an elongated ribbon that can define a length of the adjustable strap system 1101. The glider 1112 can be an adjustment mechanism that can receive the strap 1110 to adjust the length of the adjustable strap system 1101. The harness hook 1116 can be coupled to the strap 1110 by the harness hook receiver 1114. The harness hook 1116 can include a hook, loop, or other attachment interface to engage with a transfer device 100, such as with an end hook 128 as seen in FIG. 15.

The strap 1110 can include a flexible material, such as fabric, polymer, leather, or the like, or can include a rigid material, such as metal. The strap 1110 can include a substantially flat profile with a rectangular or tubular cross-section. The strap 1110 can include friction-enhancing features, such as a textured surface, a ridge, or a woven reinforcement. The strap 1110 can include an adjustable length. The adjustable length of the strap 1110 can alter a distance between the adjustable harness 1100 and a transfer device 100 when the adjustable harness 1100 is coupled to the transfer device 100. In some examples, the adjustable harness 1100 can include a first adjustable strap system and a second adjustable strap system with a different strap length than the first adjustable strap system.

The glider 1112 can modify the adjustable length of the strap 1110. A caregiver can feed the strap 1110 through a slot in the glider 1112 to slidably adjust the adjustable length of the strap 1110. A frictional force between the strap 1110 and the glider 1112 can maintain the adjustable length of the strap 1110. The glider 1112 can include a rigid material, such as a plastic, a metal, or a composite material. The glider 1112 can include an opening to receive a strap 1110. The opening in the glider 1112 can be complementary to a shape of the strap 1110. The glider 1112 can include friction-enhancing features, such as a serrated edge, a textured surface, or a spring-loaded grip. In some examples, the glider 1112 can include a locking mechanism, such as a clamp, to releasably secure the strap 1110 at a desired length.

The harness hook receiver 1114 can couple the harness hook 1116 to the strap 1110. In some examples, the strap 1110 can loop around the harness hook receiver 1114, which can couple the strap 1110 to the harness hook receiver 1114. In other examples, the harness hook receiver 1114 can be integrated into the strap 1110, such as by folding the strap 1110 into a loop.

The harness hook 1116 can couple to or with a frame connection interface on the transfer device 100, such as an end hook 128 as seen in FIG. 15. The harness hook 1116 can be attached to the harness hook receiver 1114. The harness hook 1116 can couple the adjustable strap system 1101 to the transfer device 100 when the harness hook 1116 is connected to the connection interface on the transfer device 100. In some examples, the harness hook 1116 can be rotatingly coupled to the harness hook receiver 1114. In those examples, the harness hook 1116 can be on a swivel joint, a ball-and-socket joint, or another pivot mechanism that allows the harness hook 1116 to rotate about the harness hook receiver 1114.

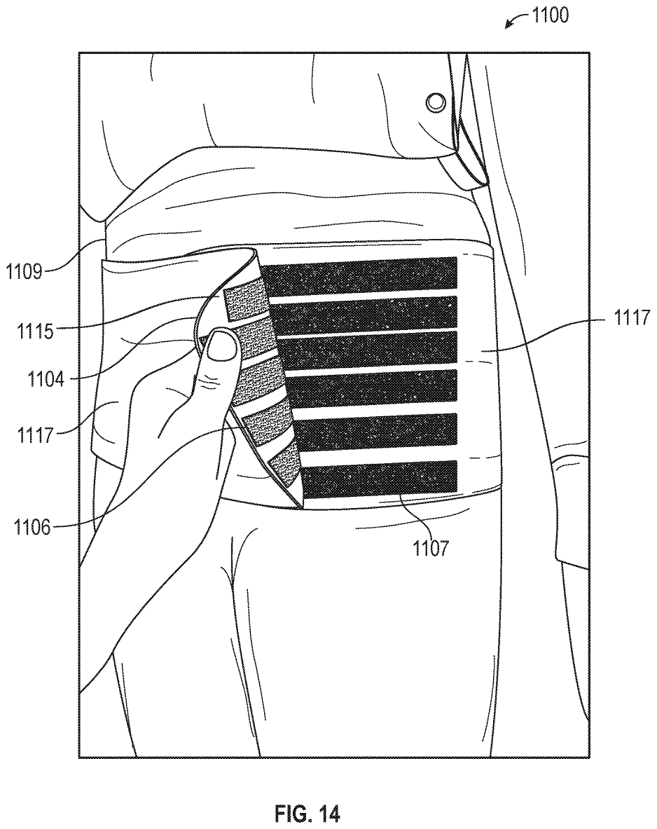

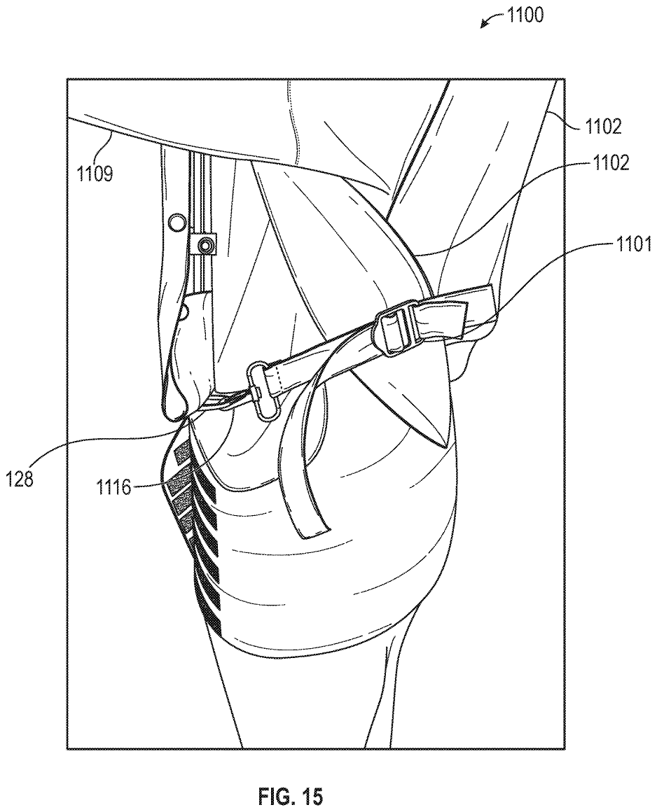

FIG. 14 illustrates a perspective view of a portion of an adjustable harness 1100 according to one example. The adjustable harness 1100 can include a waist strap 1104, a first waist coupler 1106, a second waist coupler 1107, and a caregiver 1109. The waist strap 1104 can include a first side 1115 and a second side 1117.

The waist strap 1104 can include a portion of the adjustable harness 1100 configured to wrap around a lower torso area of the caregiver 1109. The first waist coupler 1106 can be coupled to the first side 1115 of the waist strap 1104, the second side 1117 of the waist strap 1104, or the like. The second waist coupler 1107 can be coupled to the second side 1117 of the waist strap 1104, the first side 1115 of the waist strap 1104, or the like. The first waist coupler 1106 and the second waist coupler 1107 can be coupled to different or similar sides of the waist strap 1104. For example, the first side 1115 can be opposed to the second side 1117.

The first waist coupler 1106 and the second waist coupler 1107 can be disposed on the waist strap 1104 such that the first waist coupler 1106 can overlap the second waist coupler 1107 when the waist strap 1104 is wrapped around the lower torso area of the caregiver 1109, such as to couple the first side 1115 of the waist strap 1104 to the second side 1117 of the waist strap 1104 (e.g., when the adjustable harness 1100 is worn by the caregiver 1109). The first waist coupler 1106 and the second waist coupler 1107 can be attachment mechanisms to releasably couple a first end of the waist strap 1104 to a second end of the waist strap 1104.

The first waist coupler 1106 can include a portion of a releasable coupling mechanism for the waist strap 1104. The second waist coupler 1107 can complement the releasable coupling mechanism for the waist strap 1104. The first waist coupler 1106 can interface with the second waist coupler 1107 to couple the waist strap 1104 in a loop. The first waist coupler 1106 can be disposed on an interior face of the waist strap 1104, while the second waist coupler 1107 can be disposed on an exterior face of the waist strap 1104, or vice versa.

During operation, the caregiver 1109 can overlay the first waist coupler 1106 with the second waist coupler 1107. The caregiver 1109 can mechanically secure the first waist coupler 1106 to the second waist coupler 1107 to wear the waist strap 1104. During removal, the caregiver 1109 can mechanically separate the first waist coupler 1106 from the second waist coupler 1107 to remove the waist strap 1104.

In some examples, the caregiver 1109 can apply a pressure force to secure the first waist coupler 1106 to the second waist coupler 1107 to wear the waist strap 1104. In those examples, the caregiver 1109 can pull apart the first waist coupler 1106 from the second waist coupler 1107 to remove the waist strap 1104.

In some examples, at least one of the first waist coupler 1106 and the second waist coupler 1107 can be integrated with the waist strap 1104. In other examples, at least one of the first waist coupler 1106 and the second waist coupler 1107 can be secured mechanically or adhesively to the waist strap 1104.

In some examples, the first waist coupler 1106 can be a set of hooks. In these examples, the second waist coupler 1107 can be a complementary set of loops, creating a releasable hook and loop attachment interface between the first waist coupler 1106 and the second waist coupler 1107. In other examples, the first waist coupler 1106 can be an adhesive configured to adhere to the second waist coupler 1107.

Because the waist strap uses a simple and reusable coupling system, the waist strap can be easily secured to a caregiver whenever the adjustable harness is used. The caregiver can both operate and remove the waist strap without any assistance.

FIG. 15 illustrates a perspective view of a portion of an adjustable harness 1100 according to one example. The adjustable harness 1100 can include an end hook 128, an adjustable strap system 1101, a shoulder strap 1102, a caregiver 1109, and a harness hook 1116.

As discussed, the harness hook 1116 of the adjustable strap system 1101 can interface with the end hook 128 of a transfer device 100 to releasably secure the transfer device 100 to the harness hook 1116.

The shoulder strap 1102 can be looped around a shoulder or other portion of an upper extremity of the caregiver 1109. The shoulder strap 1102 can be secured by tucking an end of the shoulder strap 1102 underneath itself or underneath the adjustable strap system 1101, creating a loop around the upper extremity of the caregiver 1109.

The caregiver can quickly secure the adjustable harness to the transfer device without outside assistance. By first putting the adjustable harness on and adjusting the fit around the caregiver, the caregiver can then releasably secure the transfer device one hook at a time without help from others. The transfer device is secured next to the caregiver by securing the adjustable harness on the caregiver.

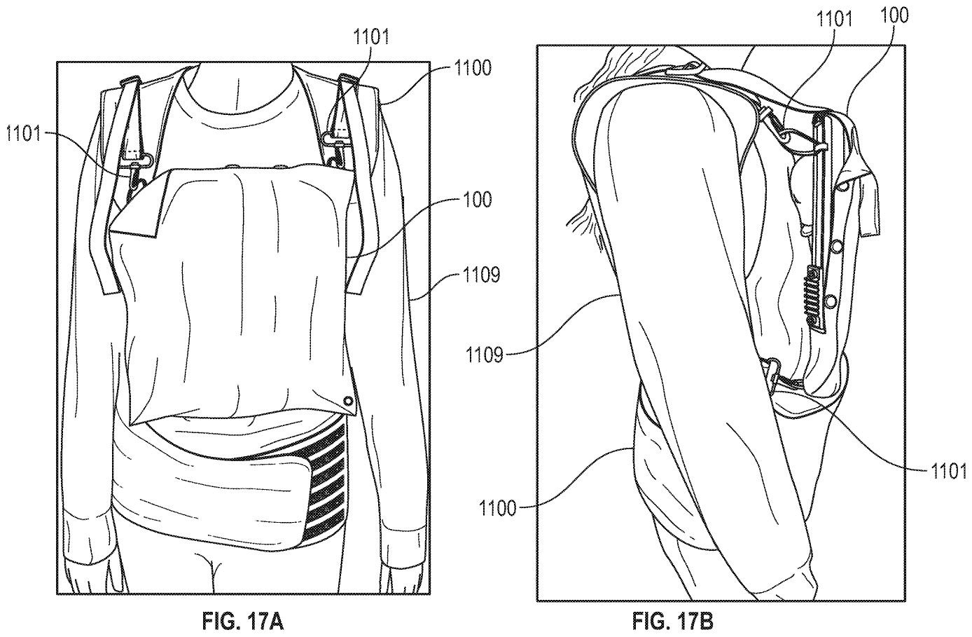

FIG. 16A illustrates a front view of an adjustable harness 1100, a transfer device 100, and an adjustable strap system 1101 in a first configuration according to one example. FIG. 16B illustrates a side view of an adjustable harness 1100, a transfer device 100, and an adjustable strap system 1101 in a first configuration according to one example. FIG. 17A illustrates a front view of an adjustable harness 1100, a transfer device 100, and an adjustable strap system 1101 in a second configuration, according to one example. FIG. 17B illustrates a side view of an adjustable harness 1100, a transfer device 100, and an adjustable strap system 1101 in a second configuration, according to one example. FIGS. 16A-B and 17A-B are discussed together below and show additional details of the adjustable harness 1100, the transfer device 100, and the adjustable strap system 1101.

In the first configuration shown in FIGS. 16A-B, the transfer device 100 can be positioned at a first location relative to the adjustable harness 1100. The first position can occur when first attaching the transfer device 100 to the adjustable harness 1100. The adjustable harness 1100 can be loosened, creating some distance between the transfer device 100 and the caregiver 1109. This first position can allow easy attachment of the transfer device 100 to the adjustable harness 1100 before facilitating skin-to-skin contact.

In the second configuration shown in FIGS. 17A-B, the transfer device 100 can be positioned at a second location relative to the adjustable harness 1100. The second position can include a position in which the transfer device 100 is closer to the adjustable harness 1100. The second position can be achieved by rotating the transfer device 100 relative to the adjustable harness 1100, such as by tightening a strap on the adjustable harness 1100. The adjustable strap system 1101 can be tightened to bring the transfer device 100 into closer proximity with the caregiver 1109. The second location can facilitate skin-to-skin contact between the caregiver 1109 and the infant 111.

During operation, the caregiver 1109 can wear the adjustable harness 1100 with the shoulder strap 1102 over a shoulder and the waist strap 1104 around a waist. The transfer device 100 containing the infant 111 can then be attached to the adjustable harness 1100 using the adjustable strap system 1101 in the initial position (FIGS. 16A-B). Once securely attached, the adjustable strap system 1101 can be tightened to bring the transfer device 100 into the closer position (FIGS. 17A-B), enabling skin-to-skin contact between the caregiver and the baby.

The adjustable harness 1100 with the transfer device 100 can provide a secure and comfortable way for a caregiver 1109 to hold the infant 111 for extended periods during skin-to-skin contact without risk of dislodging a medical line from the infant 111. Because the transfer device 100 maintains a rigid frame when picked up and the medical line is attached to the rigid frame, a force that can otherwise dislodge the medical line from the infant 111 can instead apply a force to the rigid frame. Because the medical line can be secured with more force to the rigid frame compared to the baby, the medical line 110 can withstand a greater force without dislodgement when the transfer device 100 is used relative to when the transfer device is not used.

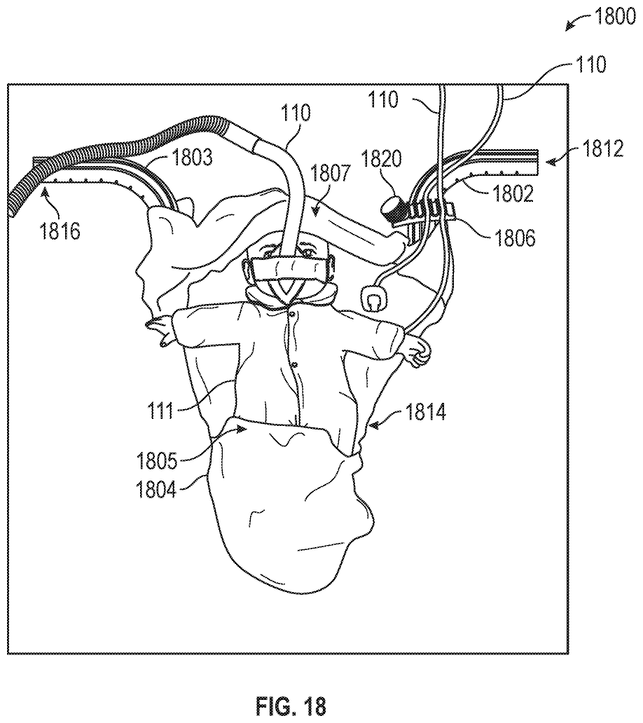

FIG. 18 illustrates a perspective view of a transfer device 1800 according to an example with the frame assembly 1802 including a V-shaped profile. The transfer device 1800 can be similar to the transfer device 100 discussed above. For example, the transfer device 1800 can transport, carry, hold, or otherwise at least partially retain or secure the infant 111. Any of the transfer devices discussed herein can include the transfer device 1800.

The transfer device 1800 can include a frame assembly 1802, a rail 1803, a hammock 1804, a first hammock pouch 1805, a fixture connector 1806, a second hammock pouch 1807, a frame first portion 1812, a frame second portion 1814, a frame third portion 1816, and a fastener 1820. The frame assembly 1802, the rail 1803, the hammock 1804, the first hammock pouch 1805, the fixture connector 1806, and the fastener 1820 can be similar to the frame assembly 102, the rail 103, the hammock 104, the hammock pouch 105, the first fixture connector 106, and the one or more fasteners 120, respectively, discussed above.

As illustrated in FIG. 18, the frame assembly 1802 can define or include a V-shaped profile, such as with a gap located or extending between the frame first portion 1812 and the frame third portion 1816. The gap can be proximate, adjacent to, or otherwise near a head, a leg, an arm, a side, or the like of the infant 111.

The frame assembly 1802 can include the frame first portion 1812, the frame second portion 1814, and the frame third portion 1816. One or more frame portions (e.g., the frame first portion 1812, the frame second portion 1814, the frame third portion 1816, or a combination thereof) can include padding, such as a padded surface, a foam material, a layer of fabric, or the like. For example, as illustrated in FIG. 18, at least a portion of the hammock 1804 can be located between the frame second portion 1814 and an end-user (e.g., the caregiver 1109 of FIGS. 16A-17B or the like), such as to provide a cushioned surface between the transfer device 1800 and the end-user.

The hammock 1804 can include one or more hammock pouches (e.g., the first hammock pouch 1805, the second hammock pouch 1807, or the like). While FIG. 18 illustrates two hammock pouches (e.g., the first hammock pouch 1805 and the second hammock pouch 1807), the transfer device 1800 or the hammock 1804 can include any number of pouches, such as one, two, three, or more pouches.

The one or more hammock pouches can be configured to restrain, retain, secure, cover, house, or otherwise support (e.g., against gravity, an external force, or the like) one or more portions of the infant 111, such as a leg, an arm, a head, a side, or the like, relative to the frame assembly 1802, the hammock 1804, or the like. For example, as illustrated in FIG. 18, the first hammock pouch 1805 can be configured to support one or more feet or legs of the infant 111, the second hammock pouch 1807 can be configured to support a head of the infant 111, or a combination thereof.

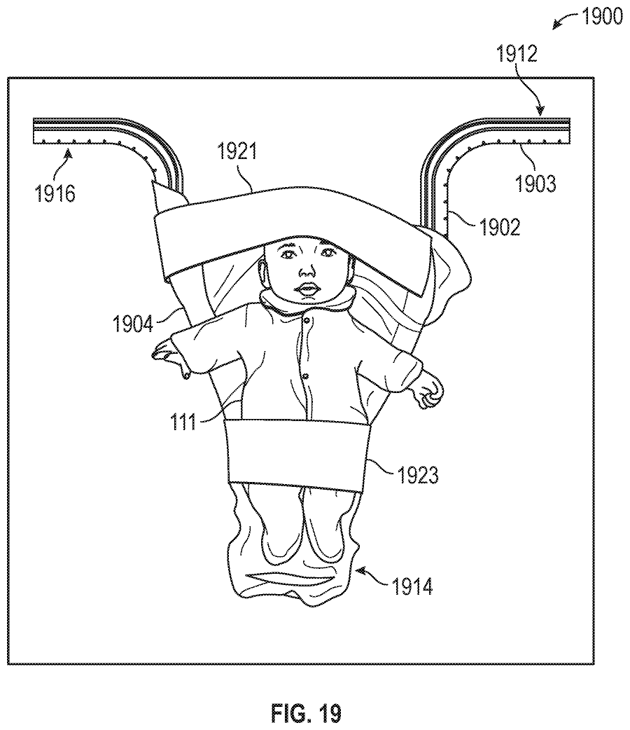

FIG. 19 illustrates a perspective view of a transfer device 1900 according to an example with a first retention member 1921 and a second retention member 1923. The transfer device 1900 can be similar to the transfer device 100 or the transfer device 1800 discussed above. For example, the transfer device 1900 can transport, carry, hold, or otherwise at least partially retain or secure the infant 111. Any of the transfer devices discussed herein can include the transfer device 1900.

The transfer device 1900 can include a frame assembly 1902, a rail 1903, a hammock 1904, a frame first portion 1912, a frame second portion 1914, a frame third portion 1916, a first retention member 1921, and a second retention member 1923. The frame assembly 1902, the rail 1903, the hammock 1904, the frame first portion 1912, the frame second portion 1914, the frame third portion 1916, the first retention member 1921, and the second retention member 1923 can be similar to the frame assembly 1802, the rail 1803, the hammock 1804, the frame first portion 1812, the frame second portion 1814, and the frame third portion 1816, respectively, discussed above.

The transfer device 1900 can include one or more retention members (e.g., the first retention member 1921, the second retention member 1923, or the like). While FIG. 19 illustrates the first retention member 1921 and the second retention member 1923, the transfer device 1900 can include any number of retention members, such as one, two, three, four, or more. The one or more retention members (e.g., the first retention member 1921, the second retention member 1923, or the like) can include a strap, a belt, a cord, a tie, a band, a tether, or the like, or a combination thereof.

The one or more retention members (e.g., the first retention member 1921, the second retention member 1923, or the like) can be configured to selectively retain the infant 111 to the transfer device 1900. For example, any of the first retention member 1921, the second retention member 1923, or the like, can be selectively movable between an open configuration and a closed configuration. In the open configuration, the infant 111 can be received into or removed from the transfer device 1900. In the closed configuration, one or more of the retention members can extend across at least a portion of the infant 111, such as to restrain the infant 111 relative to the frame assembly 1902.

The first retention member 1921, the second retention member 1923, or a combination thereof can be coupled to the frame assembly 1902, the hammock 1904, or a combination thereof. The first retention member 1921, the second retention member 1923, or a combination thereof can include a releasable coupling mechanism, such as to transition between the open configuration and the closed configuration. The releasable coupling mechanism can include a hook-and-loop fastener, an adhesive, a buckle, a clasp, a snap, a button, a magnetic fastener, a tie, a clip, or the like, or a combination thereof. In some examples, the releasable coupling mechanism can be adjustable to vary a length of the first retention member 1921, the second retention member 1923, or a combination thereof in the closed configuration, such as to accommodate different sizes of the infant 111.

The first retention member 1921, the second retention member 1923, or a combination thereof can include a natural material (e.g., linen, cotton, wool, silk, hemp, or the like), a synthetic material (e.g., polyester, nylon, acrylic, microfiber, or the like), an elastic material, or a combination thereof. In some examples, the first retention member 1921, the second retention member 1923, or a combination thereof can include padding located between the retention member and the infant 111.

The first retention member 1921, the second retention member 1923, or a combination thereof can extend around at least a portion of the transfer device 1900, such as along a side of the frame assembly 1902 configured to face a similar direction as the infant 111 (e.g., a front side), a side of the frame assembly 1902 configured to face a different direction than the infant 111 (e.g., a back side), or the like. In examples, the first retention member 1921, the second retention member 1923, or a combination thereof can extend around (e.g., entirely, at least partially, or the like) the frame assembly 1902, such as along both the front side and the back side of the frame assembly 1902, to retain the infant 111 (e.g., on opposing sides of the transfer device 1900). In examples, the first retention member 1921, the second retention member 1923, or a combination thereof can extend along the front side of the frame assembly 1902 (e.g., without extending along the back side of the frame assembly 1902), such as to provide access to the infant 111 from the back side of the frame assembly 1902. In further examples, the first retention member 1921 can extend along a different portion of the frame assembly 1902 than the second retention member 1923, such that the first retention member 1921 or the second retention member 1923 extends around (e.g., entirely, at least partially, or the like) the frame assembly 1902 while the other of the second retention member 1923 or the first retention member 1921 extends along the front side of the frame assembly 1902 (e.g., as illustrated in FIG. 19).

The first retention member 1921, the second retention member 1923, or a combination thereof can be configured to restrain, retain, secure, house, cover, or otherwise support (e.g., against gravity, an external force, or the like) one or more portions of the infant 111, such as a leg, an arm, a head, a side, or the like, relative to the frame assembly 1902, the hammock 1904, or the like. For example, as illustrated in FIG. 19, the first retention member 1921 can be configured to support the head of the infant 111, the second retention member 1923 can be configured to support one or more feet or legs of the infant 111, or a combination thereof.

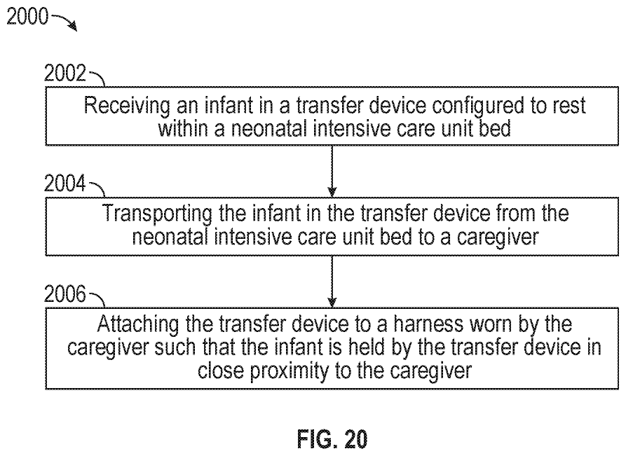

FIG. 20 illustrates a schematic view of the method 2000, according to one example. The method 2000 can include a method of operating a transfer device 100 and an adjustable harness 1100. More specific examples of the method 2000 are discussed below. The steps or operations of the method 2000 are illustrated in a particular order for convenience and clarity; many of the discussed operations can be performed in a different sequence or in parallel without materially impacting other operations. The method 2000, as discussed, includes operations performed by multiple different actors, devices, or systems. It is understood that subsets of the operations discussed in the method 2000 can be attributable to a single actor, device, or system and could be considered a separate standalone process or method.

In block 2002, the method 2000 receives the infant in a transfer device 100 configured to rest within a neonatal intensive care unit bed. The transfer device 100 can be sized to rest within the NICU bed, such as within a boundary of the NICU bed (e.g., an extent of a bedding surface, a frame, or the like). The transfer device 100 can receive the infant such that the infant rests upon a hammock of the transfer device. In some examples, the transfer device 100 can be resting on top of the NICU care bed.

In block 2004, the method 2000 transports the infant in the transfer device 100 from the neonatal intensive care unit bed to a caregiver. Transporting the infant can include lifting the transfer device 100 off the NICU bed. In some examples, a single person can transfer the infant from the NICU bed to the caregiver. In those examples, the single person can be the caregiver, a medical professional, or any other person present. In other examples, more than one person can assist with the method 2000 in block 2004.

In block 2006, the method 2000 attaches the transfer device 100 to an adjustable harness 1100 worn by the caregiver such that the infant is held by the transfer device 100 in close proximity to the caregiver. The transfer device 100 can be connected to the adjustable harness 1100 using an adjustable strap system. The transfer device 100 can be connected to the adjustable harness 1100 through one or more connections. In some examples, the adjustable strap system can be adjusted after the transfer device has received a baby. In other examples, the adjustable strap system can be adjusted prior to the receipt of the baby.

In some examples, the method 2000 can include a block in which the method 2000 secures a medical line to a connector on the transfer device 100. Securing the medical line to the connector on the transfer device 100 can include routing the medical line through a fixture connector of the transfer device 100 or placing the medical line in the fixture connector of the transfer device 100. In some examples, securing the medical line to the connector can include adjusting the location of the fixture connector on the transfer device 100, or securing the fixture connector to a determined location on the transfer device 100. In some examples, a second medical line can be secured to a second fixture connector to accommodate a second medical connection attached to a baby.

### NOTES AND EXAMPLES

The following, non-limiting examples, detail certain aspects of the present subject matter to solve the challenges and provide the benefits discussed herein, among others.

Example 1 is a transfer device for an infant comprising: a frame assembly including: a rail; and one or more connectors connected to the rail, the one or more connectors configured to couple with a medical line to secure the medical line relative to the rail; and a hammock suspended by the frame assembly, the hammock forming an area configured to capture the infant within the frame assembly.

In Example 2, the subject matter of Example 1 optionally includes a connection interface coupled to one of the rail or the one or more connectors.

In Example 3, the subject matter of Example 2 optionally includes wherein the connection interface is movably coupled to the frame assembly.

In Example 4, the subject matter of any one or more of Examples 1-3 optionally includes wherein the one or more connectors are movably coupled with the rail.

In Example 5, the subject matter of Example 4 optionally includes wherein the one or more connectors are configured to be selectively secured at a plurality of locations along the rail.

In Example 6, the subject matter of Example 5 optionally includes a removable fastener to couple the one or more connectors to the rail, the removable fastener limiting or inhibiting the one or more connectors from moving on the rail when in use.

In Example 7, the subject matter of any one or more of Examples 1-6 optionally includes wherein the rail includes a T-shaped profile and the one or more connectors include complementary T-shaped connectors configured to movably engage with the rail.

In Example 8, the subject matter of any one or more of Examples 1-7 optionally includes wherein the frame assembly is sized to fit within a neonatal intensive care unit bed.

In Example 9, the subject matter of any one or more of Examples 1-8 optionally includes wherein the one or more connectors include a channel, the channel sized to secure the medical line to the one or more connectors.

In Example 10, the subject matter of Example 9 optionally includes wherein the one or more connectors include a second channel, the second channel sized to secure a second medical line to the one or more connectors.

In Example 11, the subject matter of any one or more of Examples 1-10 optionally includes wherein the rail is U-shaped, the rail includes a first end, a second end, and a gap extending between the first end and the second end, and the hammock includes a hammock end, the hammock end folded over the first end and the second end of the rail to form a pouch at the gap, the pouch configured to receive one or more feet of the infant.

Example 12 is a neonate transfer system comprising: a transfer device including: a frame assembly including: a rail; and one or more connectors connected to the rail, the one or more connectors configured to couple with a medical line to secure the medical line relative to the rail; and a hammock suspended by the frame assembly, the hammock forming an area configured to capture a neonate within the frame assembly; a harness configured to be worn by a caregiver; and one or more connection interfaces configured to releasably couple the transfer device to the harness.

In Example 13, the subject matter of Example 12 optionally includes wherein the harness includes a superior portion, the superior portion including an adjustable shoulder strap, the superior portion including a harness attachment interface configured to releasably engage with the one or more connection interfaces.

In Example 14, the subject matter of Example 13 optionally includes wherein the harness includes an inferior portion, the inferior portion including an adjustable waist strap, the inferior portion including a second harness attachment interface configured to releasably engage with the one or more connection interfaces.

In Example 15, the subject matter of Example 14 optionally includes wherein the adjustable waist strap includes a first side, a second side, and an attachment mechanism, the attachment mechanism coupling the first side to the second side when the harness is worn.

In Example 16, the subject matter of any one or more of Examples 12-15 optionally includes wherein the one or more connection interfaces are configured to allow rotational movement of the transfer device relative to the harness.

Example 17 is a method for transporting an infant, the method comprising: receiving an infant in a transfer device configured to rest within a neonatal intensive care unit bed; transporting the infant in the transfer device from the neonatal intensive care unit bed to a caregiver; and attaching the transfer device to a harness worn by the caregiver such that the infant is held by the transfer device in close proximity to the caregiver.

In Example 18, the subject matter of Example 17 optionally includes securing a medical line to a connector on the transfer device.

In Example 19, the subject matter of any one or more of Examples 17-18 optionally includes wherein transporting the infant includes transferring the infant from the neonatal intensive care unit bed to the caregiver by a single person.

In Example 20, the subject matter of Example 19 optionally includes wherein the single person is the caregiver.

In Example 21, the apparatuses or methods of any one or any combination of Examples 1-20 can optionally be configured such that all elements or options recited are available to use or select from.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A transfer device for an infant comprising:
a frame assembly including:
a rail; and
one or more connectors connected to the rail, the one or more connectors configured to couple with a medical line to secure the medical line relative to the rail; and
a hammock suspended by the frame assembly, the hammock forming an area configured to capture the infant within the frame assembly.

2. The transfer device of claim 1, including a connection interface coupled to one of the rail or the one or more connectors.

3. The transfer device of claim 2, wherein the connection interface is movably coupled to the frame assembly.

4. The transfer device of claim 1, wherein the one or more connectors are movably coupled with the rail.

5. The transfer device of claim 4, wherein the one or more connectors are configured to be selectively secured at a plurality of locations along the rail.

6. The transfer device of claim 5, including a removable fastener to couple the one or more connectors to the rail, the removable fastener limiting or inhibiting the one or more connectors from moving on the rail when in use.

7. The transfer device of claim 1, wherein the rail includes a T-shaped profile and the one or more connectors include complementary T-shaped connectors configured to movably engage with the rail.

8. The transfer device of claim 1, wherein the frame assembly is sized to fit within a neonatal intensive care unit bed.

9. The transfer device of claim 1, wherein the one or more connectors include a channel, the channel sized to secure the medical line to the one or more connectors.

10. The transfer device of claim 9, wherein the one or more connectors include a second channel, the second channel sized to secure a second medical line to the one or more connectors.

11. The transfer device of claim 1, wherein the rail is U-shaped, the rail includes a first end, a second end, and a gap extending between the first end and the second end, and the hammock includes a hammock end, the hammock end folded over the first end and the second end of the rail to form a pouch at the gap, the pouch configured to receive one or more feet of the infant.

12. A neonate transfer system comprising:
a transfer device including:
a frame assembly including:
a rail; and
one or more connectors connected to the rail, the one or more connectors configured to couple with a medical line to secure the medical line relative to the rail; and
a hammock suspended by the frame assembly, the hammock forming an area configured to capture a neonate within the frame assembly;
a harness configured to be worn by a caregiver; and
one or more connection interfaces configured to releasably couple the transfer device to the harness.

13. The neonate transfer system of claim 12, wherein the harness includes a superior portion, the superior portion including an adjustable shoulder strap, the superior portion including a harness attachment interface configured to releasably engage with the one or more connection interfaces.

14. The neonate transfer system of claim 13, wherein the harness includes an inferior portion, the inferior portion including an adjustable waist strap, the inferior portion including a second harness attachment interface configured to releasably engage with the one or more connection interfaces.

15. The neonate transfer system of claim 14, wherein the adjustable waist strap includes a first side, a second side, and an attachment mechanism, the attachment mechanism coupling the first side to the second side when the harness is worn.

16. The neonate transfer system of claim 12, wherein the one or more connection interfaces are configured to allow rotational movement of the transfer device relative to the harness.

17. A method for transporting an infant, the method comprising:
receiving an infant in a transfer device configured to rest within a neonatal intensive care unit bed;
transporting the infant in the transfer device from the neonatal intensive care unit bed to a caregiver; and
attaching the transfer device to a harness worn by the caregiver such that the infant is held by the transfer device in close proximity to the caregiver.

18. The method of claim 17, comprising securing a medical line to a connector on the transfer device.

19. The method of claim 17, wherein transporting the infant includes transferring the infant from the neonatal intensive care unit bed to the caregiver by a single person.

20. The method of claim 19, wherein the single person is the caregiver.
